(19) United States
(12) Patent Application Publication
(10) Pub. No.: US 2003/0041765 A1
(43) Pub. Date: Mar. 6, 2003

(54) System and method for managing selection of a print shop for a print job

(76) Inventor: Chris T. Hill, Camas, WA (US)

Correspondence Address: HEWLETT-PACKARD COMPANY, Intellectual Property Administration, P.O. Box 272400, Fort Collins, CO, 80527-2400, US

(21) Appl. No.: 09/947,056

(22) Filed: Sep. 4, 2001

(51) Int. Cl. B41F 1/54; B41L 5/12

(52) U.S. Cl. 101/484

(57) ABSTRACT

A system and method for managing selection of a print shop for a print job. The method typically includes sending bid requests for a print job to plural print shops. The method further may include receiving at least one bid. The method may also include selecting a bid that meets defined criteria and directing the print shop that submitted the selected bid to print the print job.

### FIELD OF THE INVENTION

The present invention relates generally to printing, and more particularly to a method and system for managing selection of a print shop for a print job.

### BACKGROUND

In some instances, office and/or home printers are inadequate for printing large complex print jobs. Hence, users may be forced at times to take a complex print job to a commercial off-site print shop. Users may physically transport a print job to a commercial printer by storing a print job on a disk or other storage medium. Alternatively, a user may link via a public network to the print shop and submit the print job electronically.

The cost of using a commercial print shop may be high. Moreover, different print shops may charge different prices for the same job. In order to identify the most cost-effective print shop, a user typically would have to submit the print job to each print shop and then review each bid. Such a system would be time-consuming. Furthermore, a user may find that some of the print shops may not be able to complete the print job by a desired date, or the print shop may not be able to meet other requirements of the print job. It would be desirable to provide a system configured to submit bid requests for a print job to multiple print shops, and to automatically choose an optimal bid.

### SUMMARY OF THE INVENTION

Briefly, the invention includes a computer-implemented method for managing selection of a print shop for a print job. The method typically includes sending bid requests to bid a print job to plural print shops. The method further may include receiving at least one bid to print the print job from the plural print shops. The method further includes selecting a bid from the bids received from the print shops. The bid may be selected according to defined criteria. The method may also include directing the print shop which submitted the selected bid to print the print job.

### DESCRIPTION OF THE FIGURES

FIG. 1 is a computer-implemented printing system in which one embodiment of the present invention may be implemented.

FIG. 2 is a schematic diagram of a computer for the system depicted in FIG. 1.

FIG. 3 is an exemplary print request display window for the system depicted in FIG. 1, showing multiple selection menus for a print job.

FIG. 4 is a flowchart demonstrating a printing method according to one embodiment of the present invention.

### DETAILED DESCRIPTION OF THE INVENTION

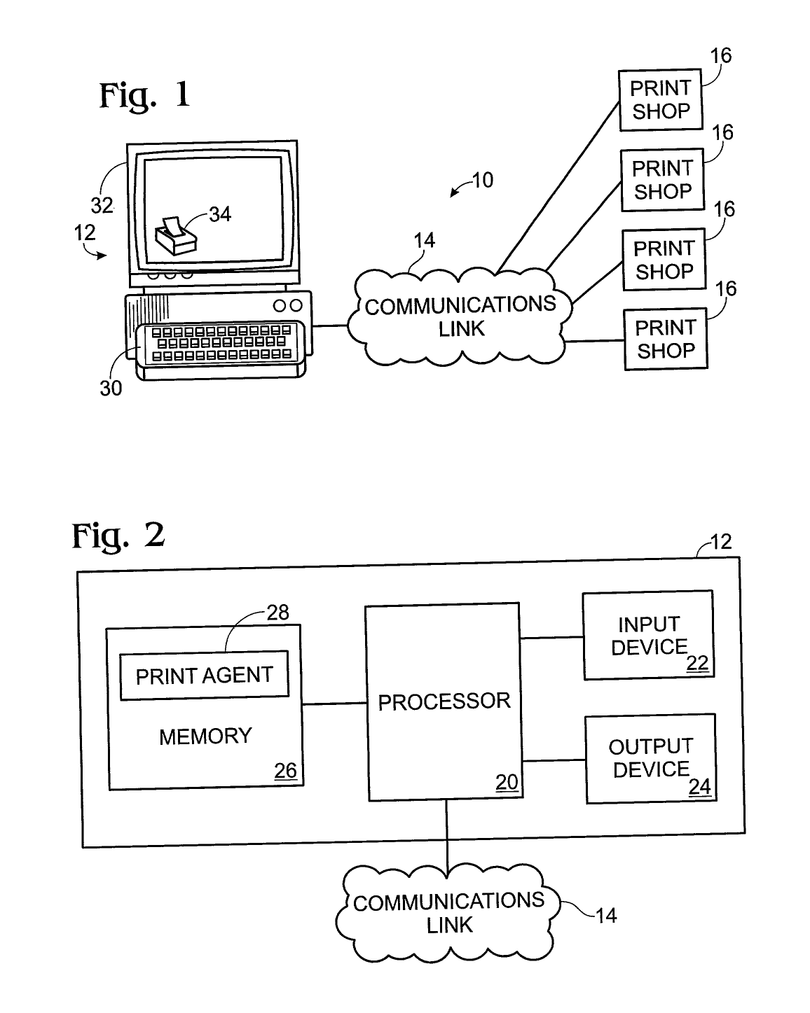

Referring initially to FIG. 1, a computer-implemented printing system for carrying out the invention is shown generally at 10. Printing system 10 typically includes a computer 12 linked via a communications link 14 to multiple print shops 16. Computer 12, in FIG. 1, is shown as a personal desktop computer, however, it should be appreciated that computer 12 may be any suitable computing device that is capable of receiving, storing, retrieving, manipulating, and sending data. For example, computer 12 may be a hand-held computer, a portable computer, a server, a series of linked computers, etc.

As shown in FIG. 2, computer 12 includes a processor 20 which may take the form of a central processing unit or other suitable processor. Computer 12 typically includes an input device 22 and an output device 24. Input device 22 may include a keyboard (as shown at 30 in FIG. 1), a mouse, a touch screen, a joystick, etc. Output device 24 may include a display monitor (as shown at 32 in FIG. 1), a printing device, etc.

Computer 12 also typically includes a storage area or memory 26. Memory 26 may include random access memory (RAM) and/or read only memory (ROM). Moreover, memory, as used herein, may include a mass storage device, which may take the form of a hard drive, floppy disk, flash memory, CD ROM drive, etc.

A print agent 28 may reside in memory 26 of computer 12. Print agent 28 is an application program or application software that may be executed by processor 20. For simplicity, and not as a limitation, print agent 28 is shown as residing in memory 26 of computer 12. However, as described above, print agent 28 may be resident in any storage medium readable by computer 12. Moreover, print agent 28 may reside on a network server or other device that is linked to computer 12. Regardless of the location of print agent 28, a user of computer 12 may have access to print agent 28. For example, in FIG. 1, an icon 34 representing print agent 28 may be present on a user's desktop. The user could access print agent 28 by dragging and dropping an electronic document onto the print agent icon 34. Similarly, print agent 28 may be accessible through a directory file.

Print agent 28 is configured to manage selection of a print shop for printing of a print job. A print job, as used herein, includes a printable file or document and any attributes that accompany it. The printable file may include any text, graphics, photographs or other suitable images. The attributes for the printable file may be user-selected or may be inherent within the print job itself. For example, user-selected attributes may include selection of the number of copies, selection of the layout, formatting instructions, selection of the quality of the draft, color selection, print resolution, finishing options (such as binding or hole-punching), selection of paper type and size, etc. These attributes are exemplary and it should be understood that other suitable attributes may be selected. Inherent attributes are intrinsic to the printable file and may include the number of pages of a document, the paper size required to print the document, etc.

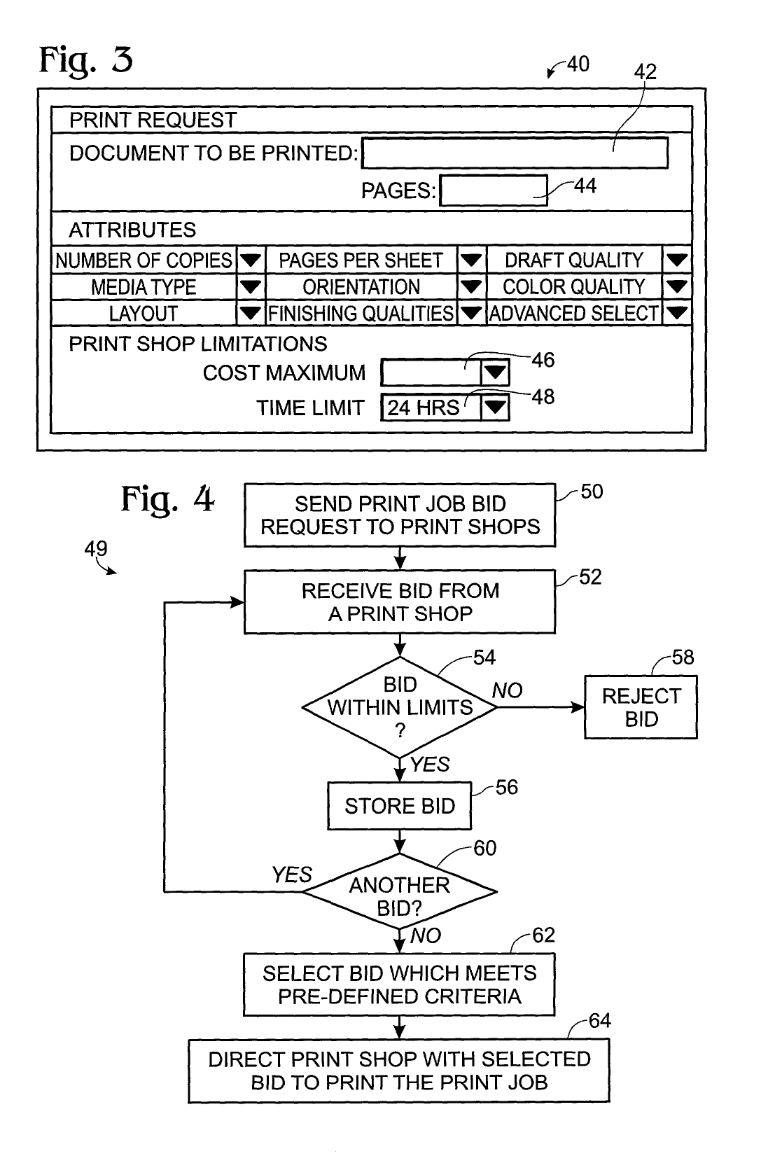

The user may submit the print job through any suitable user interface. Hence, as described above, the user may drag an electronic document onto a print agent icon 34 as shown in FIG. 1 or the user may use another suitable method to access print agent 28. The user may also submit attributes to accompany the electronic document. For example, in FIG. 3, a user interface may include a print request display window (shown generally at 40). Exemplary print request display window 40 may include user input sections which permit the user to select the document to be printed 42 and attributes of the document, such as a section which permits the user to select the number of pages of the document to be printed, indicated at 44. If the user does not define the number of pages, the number of pages may be an inherent attribute of the print job (the number of pages may default to the number of pages appropriate to print the entire printable file). Moreover, print request display window 40 permits a user to choose other appropriate user-selected customizable attributes for the print job. For example, as illustrated, a user may select for the print job: the number of copies; the media type; the layout; the pages per sheet; the orientation; the finishing qualities; draft quality; color quality; and other advanced layout and format instructions. The advanced layout and format istructions may permit a user to request customized options that are not typically available. Each attribute may be chosen using a pull-down menu (as shown) or any other appropriate selection method.

Additionally, the user may also select attributes or limitations directed to the task of printing the print job. As shown in exemplary print request display window 40, the user may input print job limits that provide a maximum cost (shown at 46) for printing the print job, or time limits (shown at 48) for printing the print job. For example, a user may request that the print job be completed within 24 hours.

Turning now to FIG. 4, a method according to one embodiment of the present invention is shown generally at 49. Generally, upon receiving a print job from a user, the print agent is configured to assemble bids from plural print shops. Bids are assembled by first sending print job bid requests to multiple print shops (as shown at 50 in FIG. 4), and then receiving bids back from the print shops (as shown at 52). The print job bid requests sent by the print agent may include the print job (where the print job includes an electronic file) and user-selected and inherent attributes for the print job. Alternatively, the print job bid requests may simply summarize the print job. For example, the print job bid requests may include the user-selected and inherent attributes of the print job, but not the actual printable file or document.

The print job bid requests typically are sent via communication link 14 to print shops 16. Communication link 14 may be a telecommunications link, an optical link, a network, or other suitable type of communications link. For example, communications link 14 may be a public network, such as the Internet. The print job bid requests are sent to multiple print shops 16 that are linked via communications link 14. Print shops 16 typically are commercial print houses that provide publishing and finishing services. These print shops may provide printing services, which may not be available in an office setting. For example, the print shop may have high-speed printers, color printers, binding and/or finishing services.

A set of linked print shops 16 receive the print job bid requests from print agent 28. Each print shop in the set of linked print shops may then submit a bid for the print job based on the print job bid request. The bid may include a time period for completing the job, the cost of completing the job, and any other requested information. The bid also may state whether the print shop is able to complete the print job as requested. The print shops which choose to submit a bid form a subset of the set of linked print shops.

As shown in FIG. 4 at 52, the print agent is configured to receive bids submitted by a subset of print shops. The print agent also may be configured to wait for bids from the set of linked print shops for an allotted period of time to allow other print shops to bid. Each bid received may be preliminarily evaluated by the print agent as to whether the bid is within defined limits (shown at 54). These limits may be user-selected attributes for the print job or default limits set by an administrator. A bid that falls within such limits may be temporarily stored (at 56), or alternatively, if the bid does not fall within such limits, the bid may be rejected (at 58). For example, if a user requests that the print job be completed within 24 hours then a print shop that sends a bid promising to complete the job in 48 hours may be preliminarily rejected by the print agent. Similarly, if a print shop is unable to complete the job on the media selected by the user or unable to meet another user-selected attribute for the print job, then the corresponding bid from the print shop may be preliminarily rejected. If numerous bids are received, each bid may be preliminarily evaluated.

The bids which fall within the limits (and which have not been rejected) are then compared to select an optimal bid. The successful bid is selected by the print agent according to pre-defined criteria (as shown at 62 in FIG. 4). The pre-defined criteria may be selected by the user or pre-selected by an office administrator. The successful bid may be selected according to only one criterion, such as cost, or on multiple criteria including cost, time to complete print job, location of the print shop, etc. Additionally, selection may include assigning various criteria relative weights and then determining through a weighted average analysis or other suitable analysis which bid most closely matches the desired criteria.

Hence, if three print shops bid on a print job and one bid was rejected (for example, because it did not have the binding facilities necessary to complete the print job as requested), then the print agent will select the successful bid out of the other two bids. The successful bid may be selected based entirely on cost where the least expensive bid is selected from all bids. Alternatively, the successful bid may be selected through a weighted analysis of several criteria, including cost, time to complete, proximity, etc. As discussed above, the criteria used for the weighted analysis may be pre-selected by an office administrator or may be user-selected. Additionally, the weight attributed to each criterion may be preset or altered by the user.

The selection step may also be configured such that even if the bids are identical only one submitted bid is the successful bid. Such a tie-breaking system may include preset defaults that select the successful bid by comparing the print shops that submitted the bids. The system may have a pre-selected preference for one print shop over another print shop in the event of submission of identical bids. Alternatively, the system may permit the user to select the successful bid and associated print shop in the event of a tie.

The print agent may notify the user at any point in the process. Thus, updates as to how many bids received and who submitted bids may be sent directly to the user. Additionally, in another embodiment of the present invention, the user may preempt or override the print agent such that the user selects the successful bid or aids in the selection of the successful bid.

After selection of the successful bid, the print agent then directs the print shop that submitted the successful bid to print the print job (shown at 64). This may include identifying the print shop associated with the successful bid and sending a printable file or document to the associated print shop, or alternatively, if the printable file or document was previously sent to the print shop with a print job bid request, then directing the print shop to print the print job may include simply notifying the print shop to proceed with completion of the print job. The print shop then completes the print job by printing the print job according to the user-selected attributes and delivering the printed materials to the user.

While the present invention has been particularly shown and described with reference to the foregoing preferred embodiments, those skilled in the art will understand that many variations may be made therein without departing from the spirit and scope of the invention as defined in the following claims. The description of the invention should be understood to include all novel and non-obvious combinations of elements described herein, and claims may be presented in this or a later application to any novel and non-obvious combination of these elements. The foregoing embodiments are illustrative, and no single feature or element is essential to all possible combinations that may be claimed in this or a later application. Where the claims recite “a” or “a first” element or the equivalent thereof, such claims should be understood to include incorporation of one or more such elements, neither requiring nor excluding two or more such elements.

I claim:

1. A computer-implemented method of automatically managing selection of a print shop for a print job, the method comprising:
sending bid requests for a print job to plural print shops;
receiving at least one bid from the plural print shops;
automatically selecting a bid which meets pre-defined criteria; and
directing a print shop which submitted the selected bid to print the print job.

2. The method of claim 1, where each bid request includes the print job.

3. The method of claim 1, where the criteria include a cost factor, and selecting a bid includes comparing the bids such that the least expensive bid is selected.

4. The method of claim 1, where the criteria include a time factor, and selecting a bid includes comparing the bids such that the bid that requires the least amount of time to complete is selected.

5. The method of claim 1, where the criteria include multiple weighted factors, and selecting a bid includes comparing the bids through a weighted analysis of the weighted factors.

6. The method of claim 1, wherein directing a print shop to a print a print job includes sending the print job to the selected print shop.

7. The method of claim 1, further comprising, prior to selecting a bid, determining whether each bid received is within defined limits, rejecting each bid that is not within the defined limits, and storing each bid that is within the defined limits.

8. The method of claim 7, where the defined limits include cost limits.

9. The method of claim 7, where the defined limits include time limits.

10. The method of claim 7, wherein the defined limits are attributes of the print job.

11. A storage medium readable by a computer, having embodied therein a program of instructions executable by the computer to perform the steps of:
sending bid requests for a print job to plural print shops via a communications link;
receiving at least one bid from the plural print shops;
automatically selecting a bid which meets pre-defined criteria;
identifying a print shop which is associated with the selected bid; and
directing the identified print shop to print the print job.

12. The storage medium of claim 11, where the criteria include a cost factor, and the instructions for selecting a bid include instructions for comparing the bids such that the least expensive bid is selected.

13. The storage medium of claim 11, where the criteria include a time factor, and the instructions for selecting a bid include instructions for comparing the bids such that the bid that requires the least amount of time to complete is selected.

14. The storage medium of claim 11, where the criteria include multiple weighted factors, and the instructions for selecting a bid include instructions for comparing the bids through a weighted analysis.

15. The storage medium of claim 11, where the instructions for selecting a bid include instructions for:
determining whether each received bid is within defined limits;
rejecting each bid that is not within the defined limits; and
storing each bid that is within the defined limits.

16. The storage medium of claim 11, where each bid request includes the print job.

17. A computer-implemented printing system for a user, comprising:
a computing device configured to receive a print request for a print job from the user; and
a computerized print agent configured to assemble a plurality of bids from multiple print shops for the print job, the print agent further configured to select a bid from the plurality of bids and to direct the print shop associated with the selected bid to print the print job.

18. The printing system of claim 17, wherein the print agent, in assembling the bids, is configured to send bid requests to multiple print shops and is further configured to receive bids submitted by the print shops.

19. The printing system of claim 17, wherein the print agent, in selecting a bid, is configured to compare the bids such that the bid that requires the least amount of time to complete is selected.

20. The printing system of claim 17, wherein the print agent, in selecting a bid, is configured to compare the bids such that the least expensive bid is selected.
